(19) United States
(12) Patent Application Publication
(10) Pub. No.: US 2008/0165735 A1
(43) Pub. Date: Jul. 10, 2008

(54) HANDOFF METHOD OF MOBILE DEVICE UTILIZING DYNAMIC TUNNEL

(76) Inventors: Jen-Jee Chen, Hualien County (TW); Yu-Chee Tseng, Hsinchu City (TW); Hung-Wei Lee, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/620,049

(22) Filed: Jan. 5, 2007

(51) Int. Cl. H04Q 7/00

(52) U.S. Cl. 370/331

(57) ABSTRACT

The present invention discloses a handoff method of a mobile device. The mobile device is currently communicating with a wireless network via a first access point. The method includes: scanning a second access point to associate the second access point; providing a dynamic tunnel between the first access point and the second access point during handoff; utilizing the second access point, the dynamic tunnel, and the first access point to access the wireless network during handoff; authenticating the mobile device; checking a dynamic host configuration protocol (DHCP) server referred to by the second access point; and utilizing the second access point to access the wireless network after handoff.

### BACKGROUND OF THE INVENTION

1. Field of the Invention

The present invention relates to a handoff method of a mobile device utilizing a dynamic tunnel, and more particularly, to a handoff method of a mobile device over IEEE 802.11 WLANs that support IEEE 802.11i Security.

2. Description of the Prior Art

IEEE 802.11 wireless networks have gained great popularity. Handoff is always a critical issue in this field, however. Wireless networks offer access to the Internet for delivery of various services such as VoIP (voice over IP) communications or multimedia stream transmissions. As a result, supporting user and device mobility is a critical issue since continuous network connectivity is highly desirable for most services. Supporting voice and multimedia services with mobility implies that the total handoff latency is required to be small. Besides, handoff also significantly reduces throughput and introduces unacceptable delays for TCP type of services. As to wireless communication, handoff refers to a mobile node (MN) moving from one access point's (AP) coverage to another's. A wireless communication handoff is composed of 4 main phases: probe-and-decision, execution, DHCP (Dynamic Host Configuration Protocol), and upper layer adjustment. In the probe-and-decision phase, a MN scans channels to find potential APs via active or passive scans and decides a target AP as its new AP, and then starts to execute the following handoff steps. Execution phase involves re-association, 802.1X authentication, and 4-way handshake. After the MN re-associates with the new AP and is re-authenticated, a data link layer or layer 2 handoff is accomplished. If the handoff occurs within the same IP subnet, this handoff is finished after the probe-and-decision and execution phases are done. The third and fourth phases are activated when an MN moves from one IP subnet to another IP subnet. In this case, after the data link layer handoff, the MN needs to renew its IP address and obtain new network configuration parameters from the new IP subnet's DHCP server. Afterwards, the MN has to adjust TCP/IP layer or applications in order to resume its original communications in the upper layer adjustment phase. The DHCP and upper layer adjustment phases comprise IP layer or layer 3 handoff.

Each of the aforementioned phases in a wireless handoff operation causes considerable delay. Significant research on improving handoff efficiency has been carried out. For example, many effective mechanisms have been presented regarding the probe-and-decision phase to reduce the original IEEE 802.11 probe latency from hundreds of milliseconds to tens of milliseconds (or even less). These mechanisms are, namely, A. Mishra, M. Shin, and W. Arbaugh, “An Empirical Analysis of the IEEE 802.11 MAC Layer Handoff Process.”, ACM SIGCOMM Comp. Commun. Rev., vol. 33, no. 2, pp. 93-102, April 2003; M. Shin, A. Mishra, and W. A. Arbaugh, “Improving the Latency of 802.11 Hand-offs using Neighbor Graphs.”, Proc. of ACM MOBISYS, pp. 70-83, June 2004; H. S. Kim, S. H. Park, C. S. Park, J. W. Kim, and S. J. Ko, “Selective Channel Scanning for Fast Handoff in Wireless LAN using Neighbor Graph”, ITC-CSCC2004, July 2004; S. Shin, A. G. Forte, A. S. Rawat, and H. Schulzrinne, “Reducing MAC Layer Hando_ Latency in IEEE 802.11 Wireless LANs”, Proc. of ACM MOBIWAC, pp. 19-26, 2004; and S. Pack, H. Jung, T. Kwon, and Y. Choi, “A Selective Neighbor Caching Scheme for Fast Handoff in IEEE 802.11 Wireless Networks”, ICC2005, 2005, which are incorporated by reference herein.

To accelerate the re-authentication phase, current IEEE 802.11i standard includes “Pre-authentication”, which permits an MN to do pre-authentication with potential APs. Unfortunately, an MN can only pre-authenticate itself to the APs located in the same IP subnet. The reference is IEEE Std. 802.11i, “IEEE Standard for Information technology—Telecommunications and information exchange between systems—Local and metropolitan area networks—Specific requirements Part 11: Wireless LAN Medium Access Control (MAC) and Physical Layer (PHY) specifications Amendment 6: Medium Access Control (MAC) Security Enhancements”, 2004. Furthermore, Pack, et al. proposes a fast handoff scheme based on mobility prediction. In their scheme, an MN performs authentication procedures for multiple APs, rather than just the current AP. The reference is disclosed by S. Pack, and Y. Choi, “Fast handoff scheme based on mobility prediction in public wireless LAN systems”, IEE Proc. Commun. vol. 151, no. 5, pp. 489-495, October 2004. In order to select these most likely next APs to pre-authenticate, an O(n²) analysis of RADIUS log information is needed. Mishra, et al. presented a proactive key distributed scheme, which obtains a 99 percent reduction in the authentication time of an IEEE 802.11 handoff. However, this conventional method only supports an intra-administrative domain authentication. The reference is disclosed by A. Mishra, et al., “Proactive Key Distribution using Neighbor Graphs”, IEEE Wireless Commun., pp. 26-36, February 2004. Moreover, it is unable to cooperate with any kinds of standard authentication processes, such as Extensible Authentication Protocol-Transparent Layer Security (EAP-TLS). The reference is disclosed by B. Aboba, and D. Simon, “PPP EAP TLS Authentication Protocol”, RFC2716, IETF, Oct. 1999.

### SUMMARY OF THE INVENTION

Therefore, an objective of an embodiment of the present invention is to provide a handoff method of a mobile device by utilizing a dynamic tunnel.

According to an embodiment of the present invention, a handoff method of a mobile device is disclosed. The mobile device currently communicates with a wireless network via a first access point. The method includes: scanning a second access point to associate with the second access point; providing a dynamic tunnel between the first access point and the second access point during handoff; utilizing the second access point, the dynamic tunnel, and the first access point to access the wireless network during handoff; authenticating the mobile device; checking a dynamic host configuration protocol (DHCP) server referred to by the second access point; and utilizing the second access point access the wireless network after handoff.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a handoff method of a mobile device according to an embodiment of the present invention.

FIG. 2 is a diagram illustrating a handoff procedure of mobile device MN that utilizes the handoff method shown in FIG. 1.

FIG. 3 is a diagram illustrating a dynamic tunnel generating procedure of the handoff method shown in FIG. 1.

FIG. 4 is a diagram illustrating dynamic tunnels in an AAA server administrative domain.

FIG. 5 is a diagram illustrating the intra-subnet handoff method of a mobile device according to an embodiment of the present invention.

### DETAILED DESCRIPTION

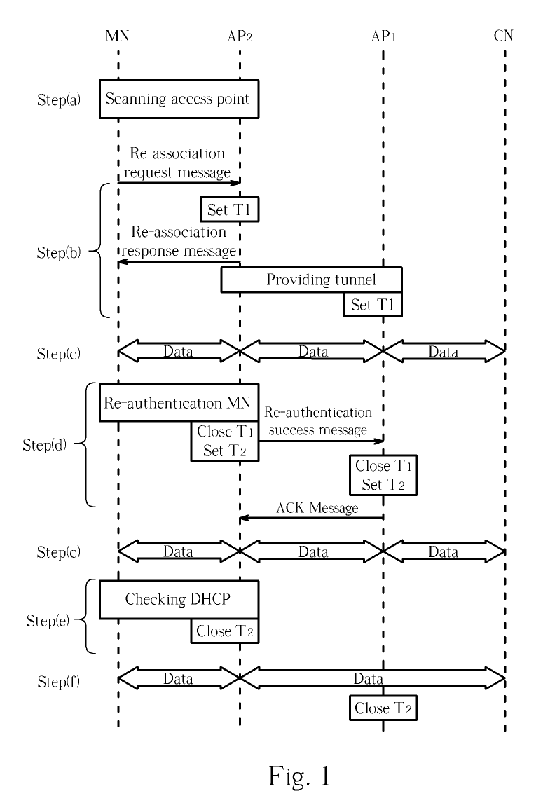

Please refer to FIG. 1, which illustrates a handoff method of a mobile device MN according to an embodiment of the present invention. The mobile device MN communicates with a wireless network CN via a first access point AP₁. In this embodiment, the method comprises the following steps: (a) scanning a second access point AP₂ to associate the second access point AP₂; (b) providing a dynamic tunnel between the first access point AP₁ and the second access point AP₂ during handoff; (c) utilizing the second access point AP₂, dynamic tunnel, and the first access point AP₁ to access the wireless network CN during handoff; (d) authenticating the mobile device MN; (e) checking a dynamic host configuration protocol (DHCP) server referred to by the second access point AP₂; and (f) utilizing the second access point AP₂ to access the wireless network CN after handoff.

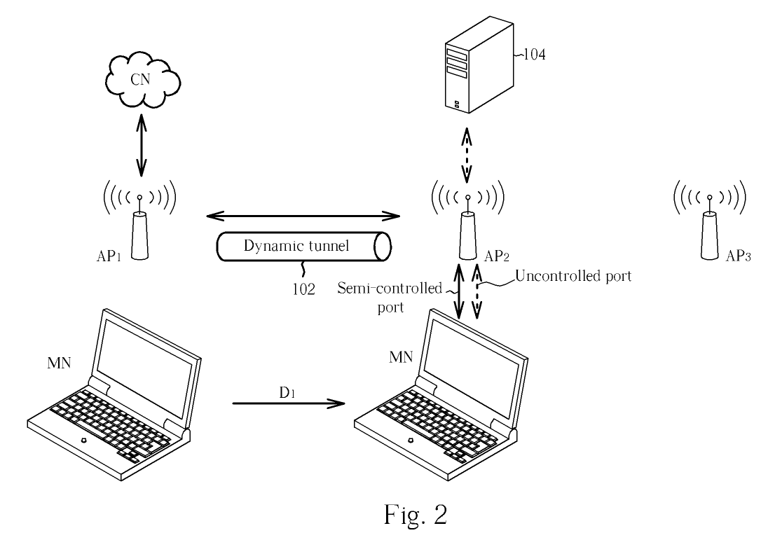

Please refer to FIG. 1 in conjunction with FIG. 2. FIG. 2 illustrates a handoff procedure of a mobile device MN that utilizes the handoff method shown in FIG. 1. As shown in FIG. 2, the first access point AP₁ and a third access point AP₃ are both neighbors of the second access point AP₂; however, the first access point AP₁ and the third access point AP₃ are not neighbors. When the mobile device MN moves along a direction D₁ and leaves a coverage area of the first access point AP₁ gradually, the signal strength with the first access point AP₁ degrades, and thus cause the mobile device MN to initiate a handoff operation to find a potential access point (e.g. the second access point AP₂). Therefore, in step (a), the mobile device MN actively sends a probe broadcast request on each channel and tries to receive responses from potential access points. After the active scan, the mobile device MN will obtain a set of potential access points around it. The mobile device MN then decides an access point (i.e. the second access point AP₂) to associate according to each access point's capability and condition. Because the consideration to select an access point from the potential access points is well known, the detailed description of deciding the second access point AP₂ is omitted, and can be found in the aforementioned references.

In step (b), the second access point AP₂ can discover the first access point AP₁ as a neighbor via re-association request messages and/or Inter-Access Point Protocal (IAPP) Move-Notify signals. Once the second access point AP₂ receives the re-association request message from the mobile device MN, it means that the mobile device MN is moving from a neighbor access point (i.e. the first access point AP₁) to the second access point AP₂; and the re-association request messages contain the address of the neighbor access point (i.e. the first access point AP₁). Furthermore, the second access point AP₂ sends back a re-association response message to the mobile device MN. Similarly, if the first access point AP₁ receives the IAPP move-notify signals from the second access point AP₂, it means that the mobile device MN is moving from the first access point AP₁ to the second access point AP₂; in other words, the second access point AP₂ and the first access point AP₁ are neighbors.

Please note that, in this embodiment of the present invention, after confirming that the first access point AP₁ is a neighbor of the second access point AP₂, the first access point AP₁ is recorded into a neighbor table that is possessed by the second access point AP₂, in which the neighbor table records neighbors of the second access point AP₂. Furthermore, in order to prevent a hostile access point, the second access point AP₂ will verify the first access point AP₁ via a session authentication, authorization and accounting (AAA) server 104. After the first access point AP₁ is confirmed to be an amiable neighbor of the second access point AP₂ with the help of the AAA server 104, the handoff method of the present invention then activates the dynamic tunnel establishment in step (b).

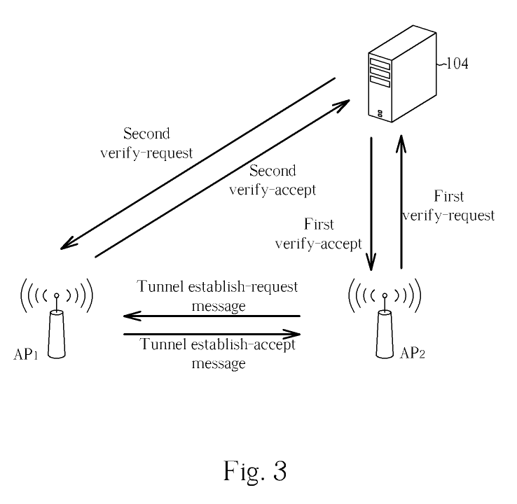

Please refer to FIG. 3. FIG. 3 illustrates a dynamic tunnel 102 generating procedure of the handoff method shown in FIG. 1. According to the present invention, the dynamic tunnel establishment is dynamically triggered by the aforementioned re-association request messages or the IAPP Move-Notify signals. As mentioned above, the second access point AP₂ will receive the re-association request messages from the mobile device MN when the mobile device MN approaches the second access point AP₂ and then enters the coverage area of the second access point AP₂. Then, the second access point AP₂ checks if the first access point AP₁ is in its neighbor table. If the first access point AP₁ does exist in the neighbor table, it means that a dynamic tunnel 102 has been established before. In the present invention, when a dynamic tunnel is established between the two neighboring access points, the established dynamic tunnel is kept active. In addition, the dynamic tunnel is allowed to be established when both access points are mutually verified as neighbors through the AAA server 104 and the neighbor information is added to the respective neighbor tables. Therefore, if the first access point AP₁ does exist in the neighbor table, then the second access point AP₂ does not have to execute the dynamic tunnel establishment since the dynamic tunnel 102 has been established and is active currently. However, if the first access point AP₁ does not exist in the neighbor table, then the second access point AP₂ performs the dynamic tunnel establishment procedure by generating a first verify-request message to the AAA server 104 as shown in FIG. 3. When the AAA server 104 receives the first verify-request message and proves that the first access point AP₁ is a valid access point, the AAA server sends the second access point AP₂ a first verify-accept message that includes the first access point AP₁'s IP address if the first access point AP₁ is valid. Contrarily, the AAA server 104 sends a verify-failure message if the first access point AP₁ is not valid. Accordingly, on receipt of the verify-failure message, the second access point AP₂ immediately abandons the dynamic tunnel establishment procedure.

Once the second access point AP₂ receives the first verify-accept message from the AAA server 104, the second access point AP₂ adds the first access point AP₁ to its neighbor table and then sends a tunnel establish-request message to the first access point AP₁ for inviting the first access point AP₁ to set up the dynamic tunnel 102 with the second access point AP₂ as shown in FIG. 3. When the first access point AP₁ receives the tunnel establish-request message, the first access point AP₁ sends a second verify-request message to the AAA server 104 to verify the second access point AP₂'s identity. Accordingly, the operation can preclude the second access point AP₂ from being a malicious party and trying to establish tunnels with the access points in wireless networks. Then, if the second access point AP₂ is verified as valid, the AAA server 104 sends a second verify-accept message to the first access point AP₁. After receiving the second verify-accept message, the first access point AP₁ adds the second access point AP₂ to its neighbor table and then sends a tunnel establish-accept message to the second access point AP₂. Accordingly, the desired dynamic tunnel 102 can be generated between the first access point AP₁ and the second access point AP₂ via the above dynamic tunnel establishment procedure.

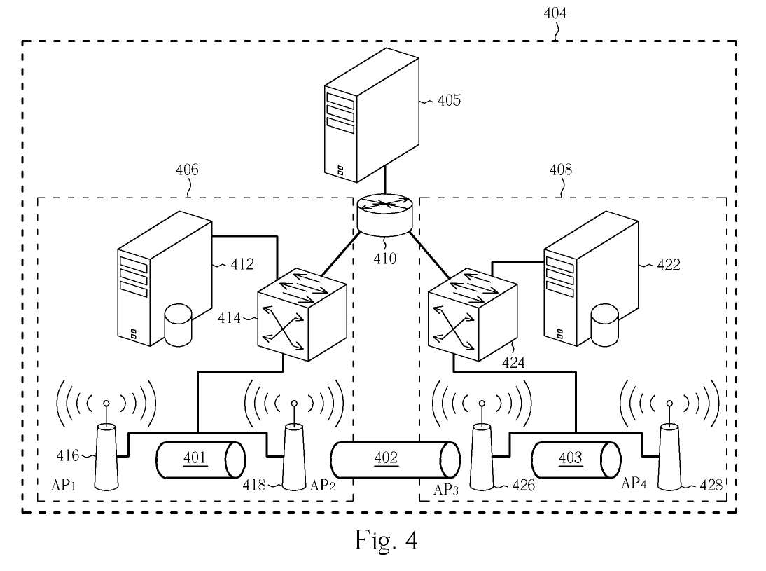

Please note that, during the dynamic tunnel establishment procedure of the handoff method shown in FIG. 1, if the first access point AP₁ and the second access point AP₂ are in the same IP subnet, the second access point AP₂ requests the first access point AP₁ to set up, for example, a layer 2 (i.e., the data link layer) dynamic tunnel; otherwise, the second access point AP₂ requests the first access point AP₁ to set up a layer 3 (i.e., the IP layer) dynamic tunnel. In other cases, a higher layer dynamic tunnel is also applicable for both the layer 2 dynamic tunnel and the layer 3 dynamic tunnel. FIG. 4 illustrates dynamic tunnels 401, 402, 403 in an AAA server administrative domain 404. The AAA server administrative domain 404 represents a service area of an AAA server 405, where it services a plurality of IP subnets 406 and 408. It should be noted that only two IP subnets are shown for simplicity; however, this is not meant to be a limitation of the present invention. The IP subnets 406 and 408 communicate with each other via a router 410. In the IP subnet 406, a DHCP server 412 and a plurality of access points 416, 418 are connected to a switch 414, where the switch 414 is further connected to the router 410. In the IP subnet 408, a DHCP server 422 and a plurality of access points 426, 428 are connected to a switch 424, where the switch 424 is further connected to the router 410. In FIG. 4, each access point 416, 418, 426, 428 has a dynamic tunnel with its neighbor. For example, the access point 426 has tunnels 402 and 403 with its neighbors, the access points 418 and 428, respectively. Since the access point 426 and the access point 418 belong to different IP subnets (i.e., the IP subnets 406 and 408), the dynamic tunnel 402 between the access point 426 and the access point 418 is a layer 3 tunnel. On the other hand, in the same IP subnet (e.g. the IP subnet 406 or 408), the dynamic tunnel 401 between the access points 416 and 418 and the dynamic tunnel 403 between the access points 426 and 428 are layer 2 tunnels.

Please refer to FIG. 1 and FIG. 2 again. Before the mobile device MN hands off from the first access point AP₁ to the second access point AP₂ completely, the mobile device MN is capable of communicating with the wireless network CN at the same time. Since the first access point AP₁ and the second access point AP₂ are neighbors, according to the invention disclosed above, the dynamic tunnel 102 will exist between the first access point AP₁ and the second access point AP₂. To handoff to the second access point AP₂, the mobile device MN sends the re-association request messages (e.g. IEEE 802.11 re-association in this embodiment) to the second access point AP₂. The re-association request messages trigger the second access point AP₂ and the mobile device MN to open a new pre-defined port (e.g. a new 802.1X port in this embodiment), which is a semi-controlled port. Meanwhile, a timer T1 at both the second access point AP₂ and the first access point AP₁ is set to count a first time period t₁ defined for temporarily permitting data relay for the mobile device MN. The original 802.1X ports do not allow the mobile device MN to access the wireless network CN before a re-authentication (step (d)); in other words, the 802.1X port, which is called the controlled port, is closed before the mobile device MN completes the re-authentication. Therefore, in order to allow the mobile device MN to perform the re-authentication and data access concurrently, the new 802.1X port is added to the mobile device MN and the second access point AP₂. During the re-authentication of step (d), the new 802.1X port is opened such that the second access point AP₂ and the mobile device MN can exchange data before the timer T1 expires. However, by using the new 802.1X port, the second access point AP₂ only acts as a relay node to tunnel the mobile device MN to the first access point AP₁ and let the first access point AP₁ process data of the mobile device MN as shown in FIG. 2. Please note that, those skilled in this art are readily to know that downlink direction data is also relayed to the mobile device MN via the second access point AP₂. However, the re-authentication should be completed within the time t₁ in order to prevent the mobile device MN from continuously accessing the wireless network CN via the second access point AP₂ and the first access point AP₁ even if the re-authentication fails.

There are two advantages to design step (c) of the disclosed handoff method for decreasing handoff effects on the mobile device MN. First, the first access point AP₁ is the only node that can determine if the mobile device MN is a legal node and has the authority to access the wireless network CN. This is because the first access point AP₁ has authenticated and authorized the mobile device MN, while the second access point AP₂ has not yet authenticated the mobile device MN. Therefore, the second access point AP₂ temporarily serves as a relay node and tunnels data to the first access point AP₁. If the mobile device MN is a valid node, the first access point AP₁ then continues supporting the mobile device MN to access the wireless network CN. This can significantly decrease the effect of a handoff for the mobile device MN. Second, in IEEE 802.11i security standard, the first access point AP₁ and the mobile device MN share a session key to encrypt/decrypt data packets. Before the mobile device MN and the second access point AP₂ negotiate a new key after the link layer handoff procedure is fully completed, the mobile device MN is still using the session key to encrypt/decrypt data packets and maintaining wireless security. During the re-authentication procedure, the mobile device MN and the AAA server 104 mutually authenticate each other. Then, the mobile device MN negotiates a specific shared session key with the second access point AP₂ if the mobile device MN passes the validation. When the re-authentication and session key negotiation are done, the mobile device MN accomplishes a layer 2 handoff and the first and the second access point AP₁, AP₂ close their respective timers T1. Accordingly, the mobile device MN and the second access point AP₂ start encrypting/decrypting data with the specific shared session key, which is possessed only by the mobile device MN and the second access point AP₂.

Then, the mobile device MN will execute a layer 3 handoff (step (e)), which contains the DHCP and higher layer adjustment. Moreover, at the time the second access point AP₂ closes the timer T1, the second access point AP₂ sets a timer T2 to count a second time t₂, in which the time t₂ represents a temporal permission of data relay during the DHCP adjustment. Meanwhile, the second access point AP₂ also sends the first access point AP₁ a re-authentication success message to notify the first access point AP₁ that the layer 2 handoff is accomplished. Therefore, the first access point AP₁ also closes the timer T1 and sets a timer T2 to count the second time t₂ when receiving the re-authentication success message, which means the temporal permission of data relay during the DHCP adjustment. Accordingly, the data tunneling continues until the time T2 expires, or the second access point AP₂ receives a DHCPACK message, which includes committed network address and configuration parameters from a DHCP sever to mobile device MN as shown in FIG. 1. The DHCPACK message indicates that mobile device MN has renewed network parameters, thus the second access point AP₂ will stop tunneling data and allows the mobile device MN to access the wireless network CN by using a new IP configuration. Meanwhile, the first access point AP₁ will continue to tunnel downloaded data until the time T2 expires.

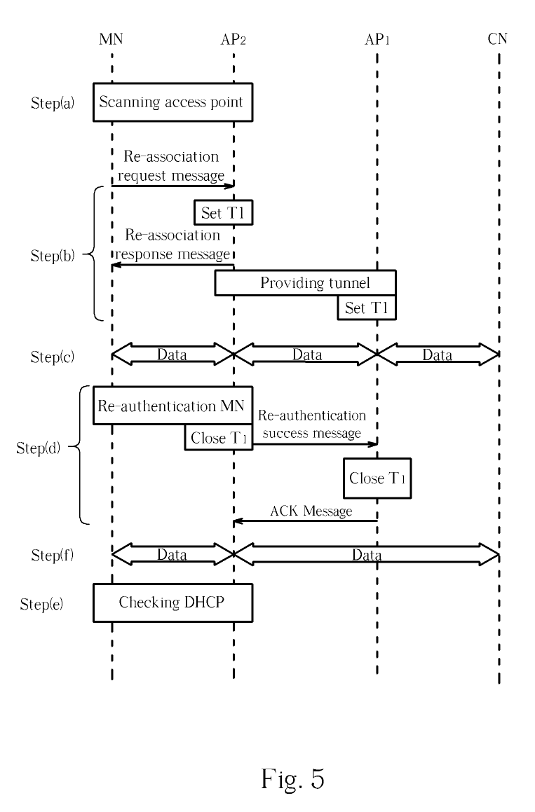

Please note that the intra-subnet handoff involves only data link layer (i.e. layer 2) handoff that can easily observe that the time T2 is unnecessarily activated and data tunneling is needless between the first access point AP₁ and the second access point AP₂ after the layer 2 handoff ends up as shown in FIG. 5. FIG. 5 illustrates the intra-subnet handoff method of a mobile device according to an embodiment of the present invention. Furthermore, in the intra-subnet handoff, the handoff method shown in FIG. 5 guarantees data access of mobile device MN during step (d) and step (e). Once the layer 2 handoff ends up in an intra-subnet handoff, the second access point AP₂ stops the intra-subnet handoff method of the present invention and processes the mobile device MN's data according to the results of the re-authentication.

In the present invention, the length of the first time t₁ and the second time t₂ are designed to tie in with the needed time of re-authentication and the DHCP adjustment respectively, as well as adding a certain percentage of additional time according to designer requirements. Accordingly, the mobile device is able to handoff within the wireless network without interruption, and therefore significantly alleviate handoff effects on services, especially real-time services. Please note that the present invention can easily be modified to suit a Mobile IP (MIP) environment, which still obeys the spirit of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A handoff method of a mobile device, wherein the mobile device communicates with a wireless network via a first access point, the method comprising:
(a) scanning a second access point to associate the second access point;
(b) providing a dynamic tunnel between the first access point and the second access point during handoff;
(c) utilizing the second access point, the dynamic tunnel, and the first access point to access the wireless network during handoff;
(d) authenticating the mobile device;
(e) checking a dynamic host configuration protocol (DHCP) server referred to by the second access point; and
(f) utilizing the second access point to access the wireless network after handoff.

2. The method of claim 1, wherein step (b) comprises:
(b1) confirming if the first access point is a neighbor of the second access point; and
(b2) establishing the dynamic tunnel according to a confirmation result of step (b1).

3. The method of claim 2, wherein step (b2) comprises:
(b2-1) when the first access point is a neighbor of the second access point, mutually verifying the first access point and the second access point with each other via a session authentication, authorization and accounting (AAA) server; and
(b2-2) when both the first access point and the second access point are verified by the AAA server, establishing the dynamic tunnel.

4. The method of claim 3, wherein step (b2-2) comprises:
sending a tunnel establish-request message to invite the first access point to set up the dynamic tunnel;
sending a tunnel establish-accept message to the second access point to inform the second access point; and
setting up a layer two (L2) tunnel or a layer three (L3) tunnel between the first and the second access points according to the tunnel establish-request message.

5. The method of claim 2, further comprising storing a second neighbor table in the second access point, wherein step (b2) comprises:
(b2-1) when the first access point is a neighbor of the second access point, searching the second neighbor table for the first access point;
(b2-2) when the first access point is not listed in the second neighbor table, mutually verifying the first access point and the second access point with each other via a session authentication, authorization and accounting (AAA) server, and establishing the dynamic tunnel if both the first access point and the second access point are verified by the AAA server; and
(b2-3) when the first access point is listed in the second neighbor table, directly utilizing a previously established dynamic tunnel between the first access point and the second access point.

6. The method of claim 5, further comprising storing a first neighbor table in the first access point, wherein step (b2-2) comprises:
adding the first access point into the second neighbor table when the first access point is verified by the AAA server; and
adding the second access point into the first neighbor table when the second access point is verified by the AAA server.

7. The method of claim 5, wherein step (b2-2) comprises:
sending a tunnel establish-request message to invite the first access point to set up the dynamic tunnel;
sending a tunnel establish-accept message to the second access point to inform the second access point; and
setting up a layer two (L2) tunnel or a layer three (L3) tunnel between the first and the second access points according to the tunnel establish-request message.

8. The method of claim 2, wherein step (b1) comprises:
utilizing the second access point to receive a re-association request from the mobile device to confirm that the first access point is a neighbor of the second access point.

9. The method of claim 8 further comprising:
starting a timer to count a first time period when the second access point receives the re-association request; and
stop utilizing the second access point and the dynamic tunnel to relay downlink and uplink data for the mobile device during handoff when the timer expires the first time period before the mobile device being authenticated in step (d).

10. The method of claim 9 being an intra-handoff method of the mobile device.

11. The method of claim 9, wherein step (e) comprises:
starting the timer to count a second time period when the mobile device is authenticated in step (d) before the first time period expires; and
stop utilizing the second access point and the dynamic tunnel to relay data when the second time period expires before the checking of the dynamic host configuration protocol (DHCP) sever is accomplished in step (e).

12. The method of claim 11, wherein step (f) comprises:
utilizing the second access point access the wireless network when the checking of the dynamic host configuration protocol (DHCP) server is accomplished before the second time period expires.

13. The method of claim 12 being an inter-handoff method of the mobile device.
